(19) United States
(12) Patent Application Publication
(10) Pub. No.: US 2005/0227072 A1
(43) Pub. Date: Oct. 13, 2005

(54) Method for the treatment of wood, wood powder and such, equipment for the treatment of wood, products made from the modified wood and products made from the treated wood powder and such

(76) Inventor: Henrikus Franciscus Maria Nijman, Leidschendam (NL)

Correspondence Address: Norman P Soloway;Hayes Soloway, 130 W Cushing Street, Tucson, AZ, 85701, US

(21) Appl. No.: 10/509,140

(22) PCT Filed: Mar. 27, 2003
(86) PCT No.: PCT/IB03/01794

§ 371 Date: Apr. 26, 2005

(30) Foreign Application Priority Data
Mar. 29, 2002 (NL) 1020280

(51) Int. Cl. B32B 5/16

(52) U.S. Cl. 428/403; 427/212

(57) ABSTRACT

The invention relates to a method, for the treatment of wood. wood powder and like through waiting with an aqueous solution, which contains one or more bifluorider. The invention relates further to the improvement of the drying of “green” wood and not completely dry wood. The invention relates to a method for the method of wood, an equipment for the realization thereof, a method for the treatment of wood powder like, wooden products consisting of treated wood powder.

The invention relates to a method for treatment of wood by means of wetting of the wood, wood powder and so with an aqueous solution containing one or more bifluorides and to products made from the treated wood itself and to products consisting of the treated wood powder.

With respect to the previous, from Dutch Patent No. 1004556 a method is known for the treatment of wood, by which the bifluoride solution contains 8-32 weights % of both potassium and ammonium bifluoride in a weights proportion of the potassium to the ammonium salt between 13:7 and 2:3. The treatment known from Dutch Patent No. 1004556 has as purpose the improvement of the moisture regulating properties of the wood or the products made from that.

A problem with green wood is that it cracks by drying too fast, with the result that per unity of volume less useful products can be made from that.

From John H. Perry, Chemical Engineer's Handbook, Second Edition, McGraw Hill Book Company, New York, p. 1509, for the solution of this problem a lumber dryer is known, by which wood is dried at elevated temperature under controlled relative humidity with heated air.

The said dryer is called “Tiemann lumber dryer” and a cross-section of this dryer is shown as FIG. 9 on p. 1509 of the previously mentioned publication.

Self-evidently drying with heated air under controlled relative humidity is quite expensive, more especially because of the heat needed.

From JP-A-07-314409 (Chem. Abs. 124:149094v) another method for impregnation of wood without the necessity of pre-drying, by which cracking of the wood is prevented, is known.

First the “green” wood is impregnated with an organic solvent, compatible with wood and miscible with water. After extraction and replacement of most of the water with organic solvent, subsequently the wood is impregnated with preserving agents soluble in the organic solvent

Self-evidently this impregnation is expensive and it can be questioned whether the organic impregnation agents used are sufficiently harmless for the environment.

The present invention intends in the first place to improve in an efficient way the moisture regulation of wood, more especially green wood (which thus contains quite an amount of water).

According to the invention the wood is immersed or sprayed on all sides during at least 3 minutes with the bifluoride solution.

With the treatment according to the invention one is not limited to the mixture of potassium and ammonium bifluoride of Dutch Patent No. 1004556, but eventually other bifluorides with a high solubility in water could be used too.

Discovered was namely that during the very short all sided wetting of the wood, the bifluoride penetrates sufficiently deep in the outer layers of the wood for improving the drying process in such an extent, that heated drying with risk of cracking becomes superfluous.

In this case the wetting of the wood has to be all sided

During a wetting of the wood, the bifluoride Ion (FHF′) from the mixed bifluoride solution penetrates very quickly in the outer layers of the wood.

As before mentioned, the invention is based on the discovery that when the amount of water capacity is greater than the amount of water present in completely dry wood, the chemisorption of FHF′ on cellulose is as if it were catalysed and therewith enters in a lasting bond with cellulose.

According to the invention one can use also in addition to the mixture of potassium and ammonium fluoride mentioned in Dutch Patent No. 1004556 another alkali bifluoride, and one can use the bifluorides separately also, provided that with wood is satisfied on the concentration of 8-32 weights %.

A preferred wetting solution is the solution mentioned in Dutch Patent No. 1004556 of potassium and ammonium bifluoride by which the weights proportion between both bifluorides is between 13:7 and 2:3.

In addition to the before mentioned alkali bifluorides, it is possible also to use one or more other bifluorides, which are fairly soluble, zinc bifluoride for instance is conceivable.

Self-evidently the wetting solution may contain other soluble metal salts in addition to one or more alkali bifluorides and/or zinc bifluoride.

Arbitrarily in the sense of thine invention it can be postulated that green wood or incompletely dry wood is wood with a moisture content above 8 weigts %.

As consequence of the treatment through all sided wetting with bifluoride solution according to the invention, the moisture content in the outer layers of the wood increases during a short time with several percents. During drying the moisture content in the outer layers of the treated wood falls rather quickly to somewhat below the initial moisture content preceding the immersion treatment.

The consequence of the wood treatment is that the outer layers with chemisorbed bifluoride dry better with conservation of the moisture regulation properties of the wood.

Preferably the all sided wetting can take place trough immersion on lath.

It is noted that in Dutch Patent No. 10045S6 on p. 5 lines 26 and 27 It is mentioned that if necessary wooden components eventually can already be placed on lath during the immersion in the solution of the combined bifluorides.

However components are wooden parts, which as a rule are made from wood pre-dried in the wood producing countries.

The method according to the invention now can advantageously be applied on “green” wood or incompletely dry wood.

As mentioned before, it has been discovered that amounts of water greater than me equilibrium concentration in dry wood accelerate greatly the penetration of the FHF′.

With “green” wood are meant tree-trunks of just felled trees, whether or not stripped of their bark or boards or beams sawed there from a short time after felling.

Self-evidently this has great consequences for the wood industry, wood can now namely almost simultaneously be treated wit bifluoride solution and dried.

The method according to the invention can advantageously be applied as follows.

One uses a bifluoride solution with a weights concentration between 8 and 16 weights % for wood with a moisture content between 10 and 35%; for more humid wood one uses a bifluoride solution with a higher weights concentration. Therefore a bifluoride solution with a weights concentration between 15 and 32 weights % is used for wood with a moisture content between 35 and 60%.

According to a preferred method and equipment, with which green wood or incompletely dry wood can be treated, is wood as with the known quick dry installation stacked in such a way on transport vehicles, that warm drying air can flow through and along the tree-trunks to be dried, one elaborates more or less on the here before mentioned “Tiemann's lumber dryer”.

With the method and equipment according to the invention, the wood is first stacked on lath in a transport container.

The equipment includes in addition to the transport container an immersion vessel with agitation means for improvement of the all sided rinsing of the wood with the bifluoride solution and means for bringing in—and out—of the transport container in the immersion vessel.

After immersion of the wood in the immersion vessel, the wood is lifted out of the bifluoride bath and is left over to draining in the immersion vessel.

After draining the wood is ready for transport in the transport container and dries due to the improved moisture regulating properties already during the transport,

The immersion vessel is hereby provided with dosing means for bifluoride solution.

The invention relates also, as mentioned in the preamble of the description, to a method for obtaining pre-treated wood powder, wood pulp, or other desintegrated products from materials with a high cellulose content, such as textile, by treatment with the bifluoride solution.

The product obtained by means of the pre-treatment is through that better suited for manufacture of formed objects or the formed objects possess better properties.

The invention relates also to objects obtained out of the pre-treated product or which consist partially thereof.

In relation to the foregoing, from JP-A-07-178727 (Chem. Abs. 123: 202600q) a cellulose powder is known, obtained from wood, bagasse or straw, which is sprayed with an anti-bacterial agent and used as filling agent for plastic mouldings (such as panels) and as coatings.

The invention now relates also to improvement of the moisture regulating properties of cellulose treated with bifluoride and/or formed objects thereof.

With treated cellulose in the sense of the invention is meant also wood pulp, cotton linters, flax fluffy and like materials, whether or not grinded straw or bagasse.

The thought of the invention to expand the invention to wood powder and such, elaborates model experiments performed in order to imitate the effect of relatively small amounts of bifluoride on the good moisture regulation of wood treated with potassium and ammonium bifluoride and to find out the probably cause thereof.

Most probable the improvement of the properties is due to chemisorption of FHF′ ions on cellulose, whereon follows complete modification.

Continuing with the obtained improved properties of the treated cellulose, it is now proposed to pre-treat with bifluoride wood powder and possibly other fairly fine products, such as cotton linters and flax fluffy after which it is the intention to convert the treated material further to useful products.

Other fairly fine products are straw, broken flax stalks and cotton fiber.

The invention relates also to wood modified with bifluoride solution or wooden products made thereof.

As mentioned before the invention relates in principle to improvement of the properties of cellulose treated with bifluoride and/or formed objects hereof.

With treated cellulose in the meaning of the invention is meant also wood powder, cotton linters, flax fluffy and like materials such as whether or not grinded straw or bagasse.

The invention elaborates on model experiments performed as a result of Dutch Patent No. 1004556 in order to imitate the effect of relatively small amounts of bifluoride on the good moisture regulation of a wood treated with potassium and ammonium bifluoride and to find out the probably cause thereof.

Most probably the improvement of the properties is due to chemisorption of FHF′ ions on cellulose.

In addition to modified wood and products manufactured there from, the invention relates also to products manufactured from the treated wood powder and like.

The invention is illustrated now with four examples and a graph with respect to the penetration depth in wood, and a graph with respect to the moisture regulation behaviour of treated cellulose.

With respect to the examples and the graph of the penetration in wood it is firstly remarked that the moisture content of wood is determined with the formula
A_{x-B×}100%, wherein
A₁₀₀
Aₓ weight of wood with a certain moisture content
A₁₀₀ weight of wood which is completely moist,
B weight of wood which is completely dry.

The weight of completely dry wood is determined through drying this during 24 hours at 110° C.

Ax is the weight of wood with a moisture content between 0 and 100%.

Further it is remarked with respect to the penetration depth of bifluorides in wood that this is determined with zirconyl-allzarine S reagent (J. H. de Boer, Chemisch Weekbiad 21, 404 (1924)).

Firstly the wood treated with bifluoride solution is sawed off transversely to the penetration depth and subsequently thinly sprayed with zirconyl-allzarine S reagent. On the spot, or penetration depth, where chemisorbed bifluoride is present, this reacts with the red-violet zirconyl-allzarine S. By the reaction with the bifluoride, the red-violet colour is changed in pale yellow (that of the liberated allzarine sulfonic acid) because of the formation of the colourless bivalent zirconium hexafluoride Ion ZrFₐ″.

With respect to the penetration depth in wood of a bifluoride solution follow first below four examples with two different concentrations of the bifluoride solution and two different humidities of the wood.

The immersion times of the wood were in all cases 10 minutes.

### EXAMPLE 1

Concentration bifluoride solution:
Humidity of the wood 13%
Penetration 12 mm

### EXAMPLE 2

Concentration bifluoride solution:
Humidity of the wood 60%
Penetration 40 mm

### EXAMPLE 3

Concentration of the bifluoride solution:
Humidity of the wood 13%
Penetration 18 mm

### EXAMPLE 4

Concentration of the bifluoride solution:
Humidity of the wood 60%
Penetration 70 mm

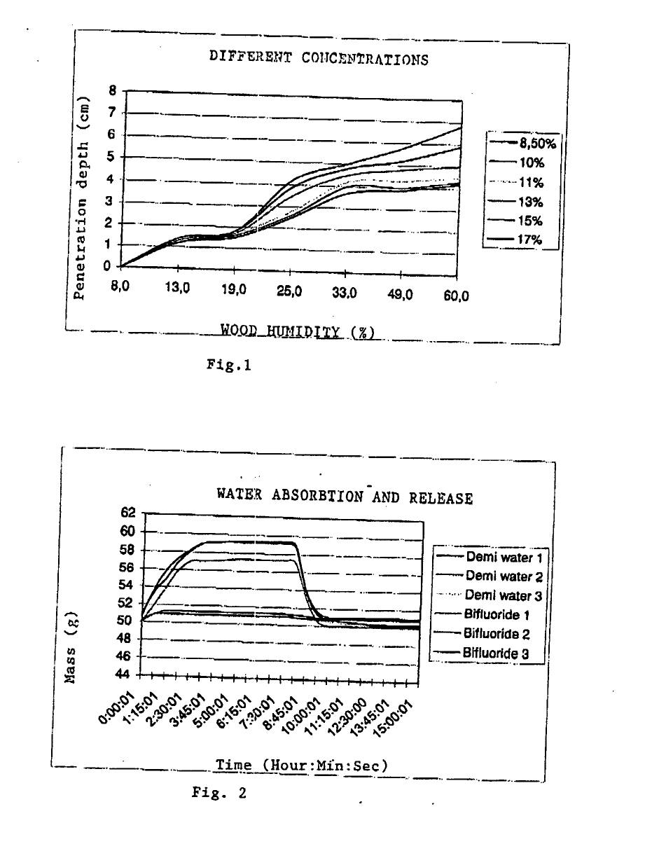

In the accompanying figures is FIG. 1 a graph, which indicates with equal immersion times (10 minutes) of wood with different humidities the relation between the penetration depth of the bifluoride solution and wood humidity for different concentrations of a bifluoride solution.

FIG. 2 is a graph, which indicates the moisture regulation behaviour of cellulose treated with different concentrations of bifluoride and cellulose treated with demineralised water only.

FIG. 1 shows, as mentioned above, the relation between penetration depth of a bifluoride solution and the wood humidity.

Along the X-axis is represented the wood humidity in percents, starting with 8.0%, which represents the percentage at heating of the wood during 24 hours at 110° C.

Along the Y-axis is represented the penetration depth determined with zirconyl-allzarine S as mentioned before. The penetration depth is indicated in cm.

In the graph of FIG. 1 are represented with respectively 1, 2, 3, 4, 5 and 6 the curves with concentrations of 17, 15, 13, 11, 10 and 8.5%.

FIG. 2 relates as mentioned before to the moisture regulating behaviour of cellulose respectively treated with a 10% mied bduodde solution and demineralised water.

As cellulose is the most important constituent of wood, the following experiments with cellulose were performed in order to demonstrate the changes in adsorption behaviour of wood.

With the experiments with cellulose six A4 sheets bleached softwood cellulose pulp were respectively immersed in bifluoride solution and demineralised water, each three pieces.

The cellulose pulp sheets weighted each about 50 grams.

The 10 seconds immersion time is beforehand determined as the maximal immersion time before the specimen disintegrates through the action of moisture.

After immersion the specimen was dried at the air during 1 minute and subsequently fastened on a weighing device in a climatic room. Subsequently, the cellulose sheet was equilibrated with the environment during 8 hours, at 23° C. at 50% RH (relative humidity) before starting the experiment

With the three experiments of cellulose treated with bifluoride and the three experiments treated with demineralised water, the cellulose sheet was first exposed to an air atmosphere of 23° C. with a RH of 85% during about 8 hours and subsequently to an air atmosphere of 23° C. with a RH of 35% during about 7 hours.

Along the Y-axis now the weight of the six test sheets is indicated in grams, the X-axis indicates the time in respectively hours, minutes and seconds.

The weights of all the six specimens at the start of the individual experiments are about 50 grams, the weights of the three cellulose sheets treated with bifluoride gradually increase with about 8 grams of water, at lowering of the RH to 35%, the absorbed water rather steeply disappears except to about 2 grams.

With a cellulose sheet treated with demineralised water only, the weight increases much less than with a specimen pre-treated with bifluoride. Herewith the increase in weight is about 1.5 grams only and returns with RH reduction much less steeply to about the weight at the start of the experiment.

In FIG. 2, in which the test results of six different experiments are indicated, the three different experiments with bifluoride are respectively indicated as BF1, BF2 and BF3.

The experiments with demineralised water are respectively indicated as DW1, DW2 and DW3.

It is noted that in FIG. 2 the curves of the water absorption and desorption in a certain way lie above those of the specimens treated with demineralised water

Prolonged experience with wood treated with bifluoride solution has shown that this through the changed water absorbtion behaviour, which is supported by the fast absorption and desorption of water with change of RH of cellulose, has improved properties with respect to wood moisture regulation.

The moisture absorption behaviour of wood changed through the treatment with bifluoride solution extends also to wood powder, wood pulp or other disintegrated products from materials with a high cellulose content.

In addition to the above mentioned concept of the improved moisture regulation of wood or disintegrated cellulose containing materials, the invention relates as mentioned before to the discovery that the penetration of aqueous bifluoride solution is if it were catalysed by moisture.

Because of this the advantage originates that one has not to impregnate under pressure or vacuum a wood preservation solution in order to obtain a sufficient penetration depth.

1. Method for the treatment of wood, wood powder and the like, by wetting with an aqueous solution of one or more bifluorides, characterized in that, more especially for the purpose of drying, one immerses or sprays the wood or the wood powder and the like during at least 3 minutes.

2. Method according to claim 1, characterized in that, one immerses the wood on lath.

3. Method according to claim 1, characterized in that, one sprays the wood all sided.

4. Method according to claim 1, characterized in that, one uses for the wetting an aqueous solution which contains one or more alkali bifluorides.

5. Method according to claim 4, characterized in that, the bifluoride solution contains potassium and ammonium bifluoride, in which the weights ratio between both bifluorides is between 13:7 and 2:3.

6. Method according to claim 1, characterized in that, the bifluoride solution contains one or more other bifluorides as for instance zinc bifluoride, and if necessary other soluble metal salts.

7. Method according to claim 1, characterized in that, one applies the method on grenn wood or incompletely dry wood.

8. Method according to claim 7, characterized in that, one applies a mixed bifluoride solution with a weights concentration between 8 and 15 weights % with wood with a moisture content between 10 and 35% and a mixed bifluoride solution with a weights concentration between 15 and 32 weights % with wood with a moisture content between 35 and 60%.

9. Method according to claim 1, wherein airily stacked wood is placed on a transport container, and subsequently immersed on all sides in aqueous bifluoride solution and after draining, if desired dried and transported.

10. Equipment for performing the method according to anyone of claims 1, 2, 3, 4, 5, 6, 7, 8 or 9, comprising a transport container for wood, wherein wood can be airily stacked, characterized in that, the equipment further comprises an immersion vessel wherein fits the immersion vessel provided with agitating means arid transporting means for bringing in and bringing out of the transport container and dosing means for supply of bifluoride solution.

11. Modified wood or wooden products produced according to the method of any one claims 1, 2, 3, 4, 5, 6, 7, 8 or 9, characterized in that, this contains in the outer layers about 15% moisture.

12. Products manufactured from wood powder and the like treated with bifluoride solution according to the method of any one of claims 1, 2, 3, 4, 5, 6, 7, 8 or 9.
